(19) United States
(12) Patent Application Publication
(10) Pub. No.: US 2012/0211409 A1
(43) Pub. Date: Aug. 23, 2012

(54) PHOTOVOLTAIC REVERSE OSMOSIS SYSTEM WITH THERMAL MANAGEMENT

(75) Inventors: Steven Dubowsky, Boston, MA (US); Amy M. Bilton, Florence (CA); Leah C. Kelley, Brighton, MA (US)

(73) Assignee: Massachusetts Institute of Technology, Cambridge, MA (US)

(21) Appl. No.: 13/032,896

(22) Filed: Feb. 23, 2011

(51) Int. Cl. B01D 29/00

(52) U.S. Cl. 210/251

(57) ABSTRACT

Photovoltaic-powered reverse osmosis system. The system includes a photovoltaic panel for generating electricity and includes a heat exchanger in thermal contact with the photovoltaic panel. The salt-containing feed water is fed to a reverse osmosis unit to produce clean water therefrom. Fluid circuitry, including a pump, circulates the feed water through the heat exchanger to cool the photovoltaic panel and to heat the feed water. It also delivers the heated feed water to the reverse osmosis unit for desalination. Cooling the solar panel and heating the RO feed water increases the total amount of clean water produced. In a preferred embodiment, a thermal controller manages the temperatures of the photovoltaic panel and the feed water by controlling the flow of feed water through the fluid circuitry. The photovoltaic panel temperature is minimized and the temperature of the feed water is maximized subject to a constraint on maximum feed water temperature.

### BACKGROUND OF THE INVENTION

This invention relates to a photovoltaic-powered reverse osmosis system for water desalination, and more particularly to such a system which the reverse osmosis feed water is used to cool the photovoltaic solar panel increasing overall system efficiency.

Reverse osmosis is a well-known technology for desalination of brackish groundwater and sea water. A prior art basic photovoltaic-reverse osmosis (PV/RO) system is shown in FIG. 1. The system includes a solar panel 100, a motor that drives a positive-displacement pump 102, a reverse osmosis membrane 104 housed in a pressure vessel 106, an energy recovery device such as a pressure exchanger 108 and the system's power electronics 110. The solar panel 100 produces electrical power that is conditioned by a DC to DC converter within the power electronics 110 and used to drive the pump 102. The pump 102 pressurizes the incoming saline water and Reds it into the pressure vessel 106, which contains the reverse osmosis membrane 104. When teed water pressure is higher than its osmotic pressure, water flows across the semi-permeable reverse osmosis membrane 104, producing fresh water. The salt is left behind in a high-pressure brine. This brine exits the reverse osmosis membrane unit 106 and flows into the energy recovery unit 108 where some of the energy is extracted and used to help pressurize the input feed water.

Reverse osmosis is an energy-intensive process. Hence, the use of solar energy is attractive. While it is known to use a photovoltaic panel o generate electricity for use in a reverse osmosis system, it has been unappreciated that thermal management of the PV/RO system can increase overall system efficiency.

It is therefore an object of the present invention to improve the efficiency of a PV/RO system by using the salt-containing feed water to cool the photovoltaic panel and thereby to heat the feed water before it enters the reverse osmosis pressure vessel.

### SUMMARY OF THE INVENTION

The photovoltaic-powered reverse osmosis system according to the invention includes a photovoltaic panel for generating electricity and has a heat exchanger in thermal contact therewith. A reverse osmosis unit is provided for receiving salt-containing feed water to produce clean water therefrom. Fluid circuitry, including a motor, is provided for circulating the feed water through the heat exchanger to cool the photovoltaic panel and to heat the feed water. The fluid circuitry also delivers the heated feed water to the reverse osmosis unit for desalination. A thermal controller in a preferred embodiment determines the flow of the feed water through the fluid circuitry and increases clean water production by managing temperatures of the photovoltaic panel and the feed water.

This system is constructed from modular components. The individual components, such as pumps, photovoltaic panels, and reverse osmosis membranes, can be mass-produced at low cost. This enables efficient systems to be custom configured for a particular location and demand.

In a preferred embodiment, the motor drives a positive displacement pump for delivering the feed water to the reverse osmosis unit. In this embodiment, it is preferred that the photovoltaic panel temperature be minimized. The reverse osmosis feed water temperature in this embodiment is maximized subject to a constraint on maximum feed water temperature.

### BRIEF DESCRIPTION OF THE DRAWING

FIG. 1 is a schematic representation of a basic prior art PV/RO system.

FIG. 2 is a graph of power versus voltage showing the effect of photovoltaic panel temperature on the electrical power produced.

FIG. 3 is a graph of specific energy versus feed pressure showing that the specific energy required for desalination decreases as feed water temperature rises.

FIG. 4 is a schematic illustration of a PV/RO system with active temperature control and solar concentrating mirrors according to an embodiment of the invention.

FIG. 5 is a schematic illustration of an embodiment of the thermal controller disclosed herein and including three controllable valves.

FIG. 6 is a schematic illustration of thermal controller operation according to an embodiment of the invention.

FIG. 7 is a schematic illustration showing thermal controller operation when the photovoltaic panel is too warm and requires more water than needed by the reverse osmosis system.

FIG. 8 is a schematic illustration showing thermal controller operation according to an embodiment of the invention when the reverse osmosis feed water used to cool the photovoltaic panel has exceeded its allowable maximum temperature and requires cooling before entering the reverse osmosis unit.

FIG. 9 is a schematic illustration of a thermal control subsystem used in an embodiment of the invention.

FIG. 10 is a feedback block diagram of an embodiment of the thermal management system disclosed herein.

FIG. 11 is a photograph of an experimental PV/RO system.

FIG. 12 is a schematic representation of the experimental PV/RO system.

FIG. 13 is a graph of power versus time showing the electrical power produced by e photovoltaic panel in an experiment.

FIG. 14 is a graph of clean water accumulated versus time produced by an embodiment of the invention in the experimental set-up.

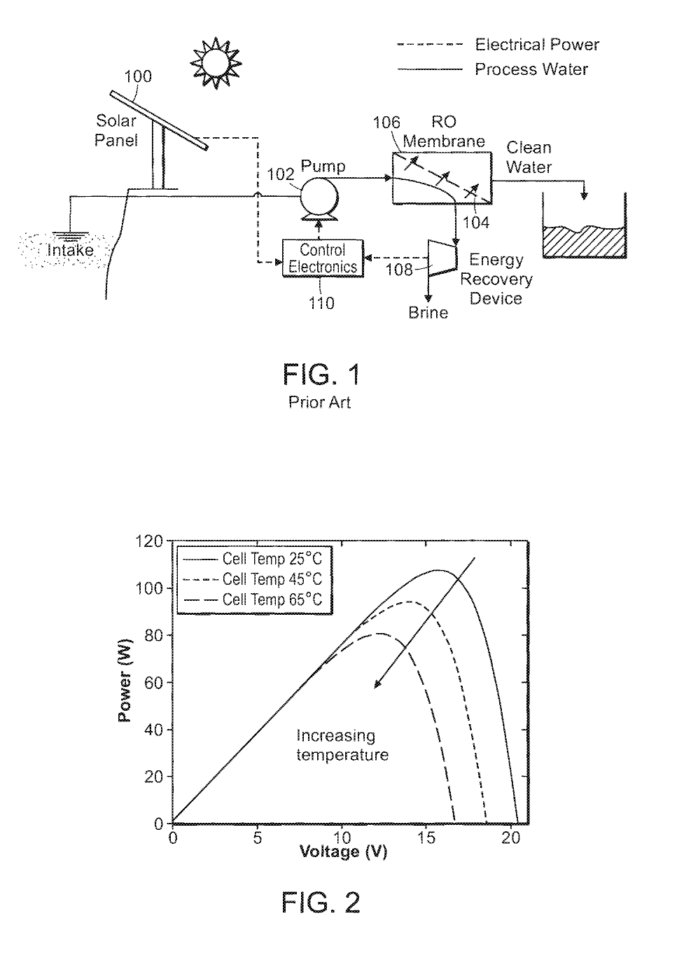

### DESCRIPTION OF PREFERRED EMBODIMENT

Solar panels and reverse osmosis membranes possess complementary characteristics that can be exploited to improve the overall system efficiency. Numbers in brackets refer to the references included herewith, the contents of all of which are incorporated herein by reference in their entirety. FIG. 2 shows the effect of increasing the solar panel temperature on the electrical power produced. The solar panel conversion efficiency decreases with increasing temperature [1], for the same amount of incoming solar radiation. Therefore, cooling the solar panel will increase the electrical energy produced.

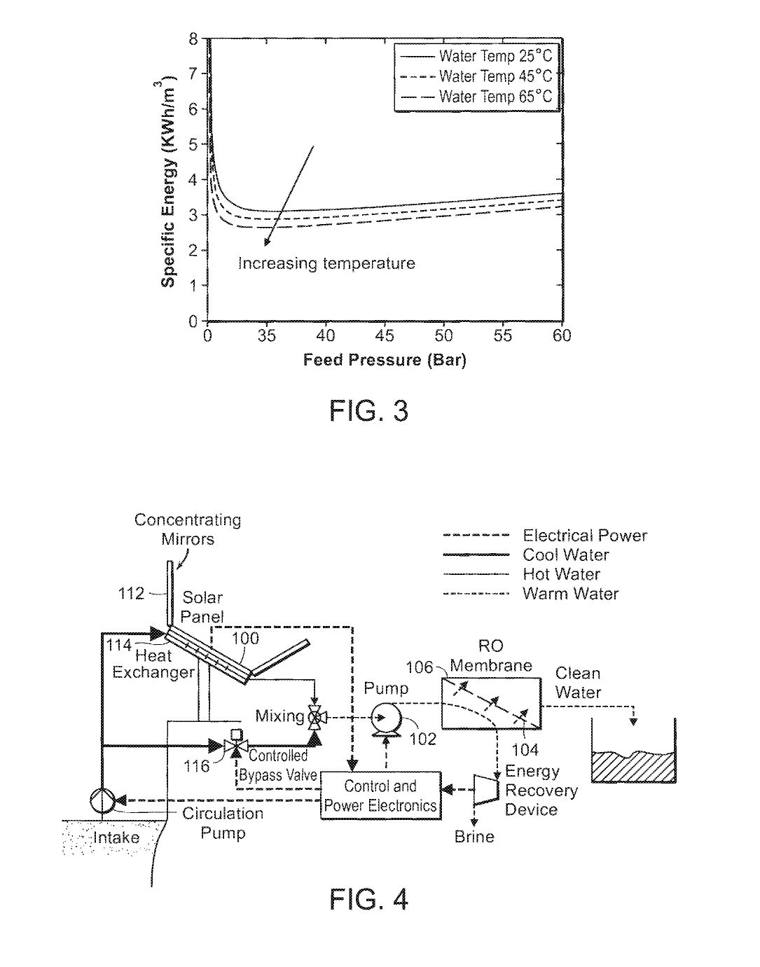

FIG. 3 shows the effect of increasing the feed water temperature on the energy required for the RO to produce a given amount of fresh water for a given pump pressure. As the temperature of the feed water increases, the amount of energy required to desalinate water decreases, despite increasing the osmotic pressure. This occurs since the membrane permeability increases with increasing temperature. Thus, warming the reverse osmosis feed water will increase flow of clean water through the membrane, as long as its temperature remains below the maximum operating temperature specified by the manufacturer, typically around 45° C. [2]. Above this temperature, the polymer osmosis membrane will start to break down.

These thermal characteristics are complementary. By cooling the PV panel with the incoming feed water, additional electrical power can be produced by the solar panel while warming the feed water, for a greater fresh water production. The ability to cool the PV panels also permits the addition of simple, low-cost concentrating mirrors to the PV panels, increasing the total amount of clean water produced without overheating the solar panel. An active control that manages these temperatures is required to maximize water production, without either the panel or the RO overheating.

FIG. 4 is a schematic of a PV/RO system with temperature management and includes solar concentrating mirrors 112. In this system, a circulating pump 102 drives the source water through both a heat exchanger 114 mounted on the back of the PV panel 100 and a controllable bypass valve 116. The circulation pump 102 and the bypass valve 116 settings are determined by the solar panel and RO feed water temperatures using the control scheme outlined below. If the panel is too hot, the controllable valve 116 will reduce its flow so that more water flows through the heat exchanger. If the RO feed water is too hot, the bypass valve will increase its opening in response; meanwhile circulating flow must insure that the RO is not starved for water. The controller must respond to variations in solar panel temperature and system power, which will change with passing clouds and with sun position in the sky.

The thermal controller maximizes the clean water produced by a PV/RO system by managing the temperatures of the PV panel and the RO feed water in response to changes in the incoming solar radiation, ambient air temperature and source water temperature. This is accomplished by controlling the flow of water through the heat exchanger 114 by changing the operating points of the valves and pumps in the stem. Assuming that the incoming feed water temperature T_{w} is below the maximum solar panel temperature T_{p,max} and the maximum membrane temperature T_{RO,max}, the feed water flow rate through the PV panel heat exchanger can be controlled such that the panel temperature Tₚ is minimized and the reverse osmosis temperature T_{RO} is maximized, which in turn will maximize clean water production qₚ. Using the nomenclature given in Table 1, this problem can be written as

maximize(qₚ) (1)

subject to the following typical constraints:

$$\begin{matrix}{T}_{p} < 80 ° C . & ( 2 ) \\ {T}_{RO} < 45 ° C . & ( 3 ) \\ {P}_{HEX} \leq {P}_{HEX , max} & ( 4 ) \\ {P}_{feed} > {π}_{w} & ( 5 ) \\ {q}_{p} = {KA}_{m} {T}_{corr} pf ( {P}_{feed} - {π}_{w} ) & ( 6 ) \\ {T}_{corr} = exp [ 2640 ( \frac{1}{298} - \frac{1}{273 + {T}_{RO}} ) ] ; {T}_{RO} \geq 25 ° C . & ( 7 ) \\ {T}_{corr} = exp [ 3020 ( \frac{1}{298} - \frac{1}{273 + {T}_{RO}} ) ] ; {T}_{RO} \leq 25 ° C . & ( 8 ) \\ pf = exp [ 0.7 ( \frac{{q}_{p}}{{q}_{f}} ) ] & ( 9 ) \\ {C}_{p} \leq 500 ppm & ( 10 ) \\ {C}_{p} = \frac{{BA}_{m} {T}_{corr} pf [ ( {C}_{f} + {C}_{b} ) / 2 ]}{{q}_{p}} & ( 11 ) \\ {P}_{feed} = f ( {𝒫}_{elec} ) & ( 12 ) \\ {𝒫}_{elec} = {IA}_{p} η ( 1 + k Δ T ) & ( 13 ) \\ Δ T = {T}_{p} - 25 ° C . & ( 14 ) \\ {C}_{pan} \frac{d {T}_{p}}{d t} = {Q}_{sol} - {P}_{elec} - {Q}_{sky} - {Q}_{air} - {Q}_{wtr} & ( 15 ) \\ {Q}_{sol} = {IA}_{p} & ( 16 ) \\ {Q}_{sky} = {A}_{p} ɛσ ( {T}_{p}^{4} - {T}_{sky}^{4} ) & ( 17 ) \\ {Q}_{air} = {h}_{air} {A}_{p} ( {T}_{p} - {T}_{air} ) & ( 18 ) \\ {Q}_{wtr} = {h}_{wtr} {A}_{p} ( {T}_{p} - {T}_{wtr} ) & ( 19 ) \\ {T}_{wtr , out} = {T}_{wtr} + \frac{{Q}_{wtr}}{\dot{m} {c}_{p , w}} & ( 20 ) \\ {T}_{RO} = \frac{{T}_{wtr , out} {q}_{HEX} + {T}_{wtr} {q}_{bypass}}{{q}_{hex} + {q}_{bypass}} & ( 21 )\end{matrix}$$

TABLE 1
Nomenclature for PVRO System Equations

| Symbol | Definition |
|---|---|
| Tₚ | Temperature of the solar panel |
| T_{RO} | Temperature of the feed water entering the RO unit |
| qₚ | Volumetric flow rate of fresh water produced by the RO unit |
| P_{HEX} | Pressure at the heat exchanger inlet |
| P_{feed} | Pressure of the feed water, a function of the power supplied |
| | by the solar panel |
| π_{w} | Osmotic pressure of the water, temperature dependent |
| K | RO membrane permeability to water |
| Aₘ | Surface area of the RO membrane |
| T_{corr} | Temperature-dependent correction factor for the RO membrane |
| pf | Polarization factor for the RO membrane |
| q_{f} | Volumetric flow rate of the feed water |
| Cₚ | Concentration of salt in the fresh water |
| B | RO membrane permeability to salt |
| C_{f} | Concentration of salt in the feed water |
| C_{b} | Concentration of salt in the brine exiting the RO pressure vessel |
| [symbol] | Electric power produced by the solar panel |
| I | Incident solar radiation per square meter |
| Aₚ | Area of the solar panel |
| η | Solar radiation-to-electrical power conversion efficiency of the |
| | solar panel at standard test conditions (25° C.) [3] |
| k | Temperature correction coefficient for the solar panel |
| | (negative number) [3] |
| Cₚₐₙ | Heat capacity of the solar panel |
| Qₛₒₗ | Incoming solar radiation incident on the panel |
| Q_{sky} | Thermal radiation between the solar panel and the sky |
| Qₐᵢᵣ | Convective heat transfer between the solar panel and the |
| | ambient air |
| Q_{wtr} | Heat transferred from the solar panel to the feed water |
| ε | Emissivity of the solar panel |
| σ | Stefan-Boltzmann constant |
| T_{sky} | Sky temperature in Kelvins |
| hₐᵢᵣ | Convective heat transfer coefficient between the solar panel and |
| | the air |
| Tₐᵢᵣ | Ambient air temperature |
| h_{wtr} | Forced convection heat transfer coefficient between the solar |
| | panel and the water |
| T_{wtr} | Temperature of the source water |
| T_{wtr,out} | Temperature of the water leaving the heat exchanger |
| m | Mass flow rate of the water through the heat exchanger |
| c_{p,w} | Specific heat of the source water |
| q_{HEX} | Volumetric flow rate of water through the heat exchanger |
| q_{bypass} | Volumetric flow rate of feed water bypassing the heat exchanger |

Equations (2) and (13) are based on manufacturer data [3]. Equations (6-9) and (11) are from [4]. Details on the development of Equations (15-21) are based on [5].

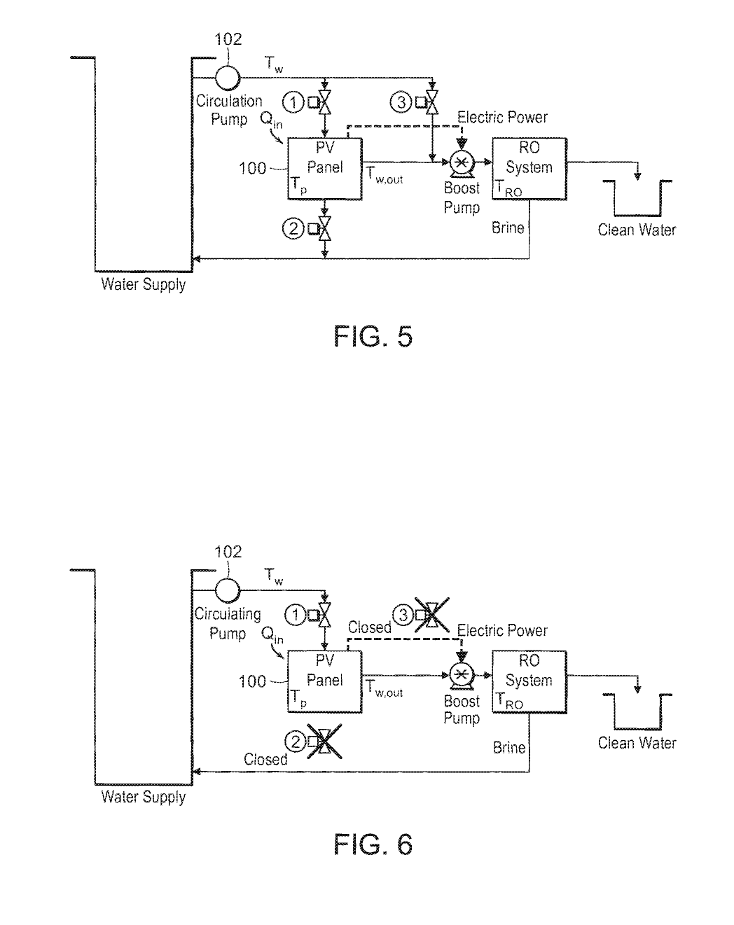

FIG. 5 is a schematic of a more general thermal controller for a PV/RO system. It contains three controllable proportional valves that can open and close in response to changes in the PV panel and. RO water temperatures. Valve 1 controls the flow rate of water entering the PV panel heat exchanger. Valve 2 controls the water flow exiting the PV panel that does not pass through the RO system. Valve 3 is a bypass valve that controls the flow of cool water into the RO system. In general the flow through the PV panel will mix with the flow through valve 3 before they enter the RO unit. In general these valves will be capable of proportional control to achieve variable flow rates, rather than only being able to be simply opened or closed.

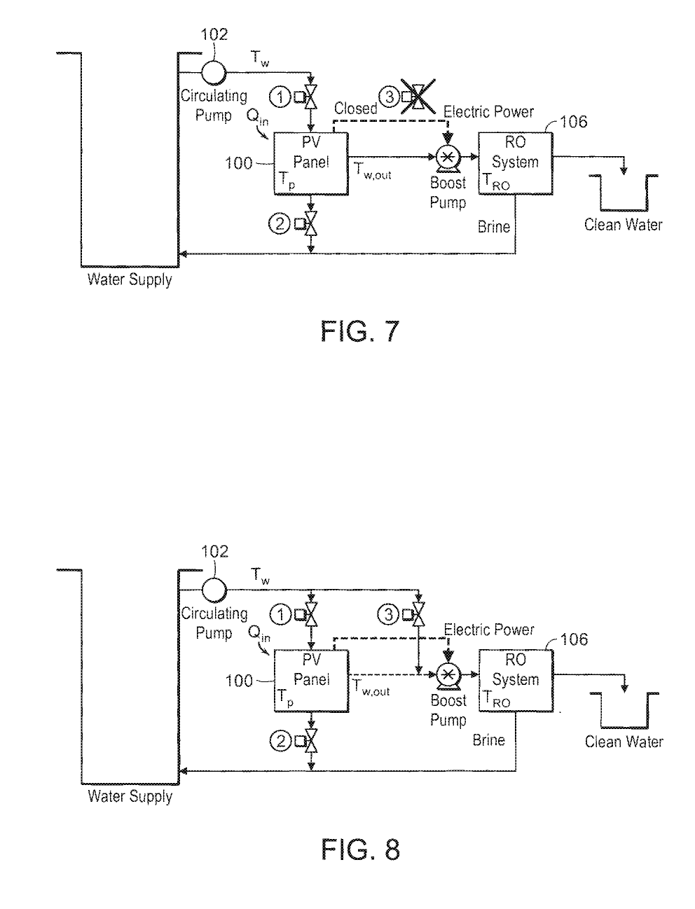

FIG. 6 shows the system configuration when the PV panel is kept cool using the RO feed water, which has not reached its maximum allowable temperature. Valve 1 is opened and the others are closed, so all the RO feed water is heated as it cools the PV panel. FIG. 7 shows the system configuration when the PV panel is too hot and requires more water for cooling than required by the RO system. In this case, valve 1 is completely open and valve 2 is open to some degree. The flow of water from the PV panel to the pump and the RO system is determined by the position of valve 2.

FIG. 8 shows the system configuration when the water used to cool the PV panel exceeds the maximum allowable temperature of the RO unit and must be cooled before entering the pump. In this case, all the valves are open to the appropriate positions so that the temperature of the RO unit is below its maximum temperature, the PV panel is sufficiently cooled, and the boost pump is not starved for water and does not need to pull a vacuum. The flow rate of heated water into the RO unit is determined by the position of valve 2.

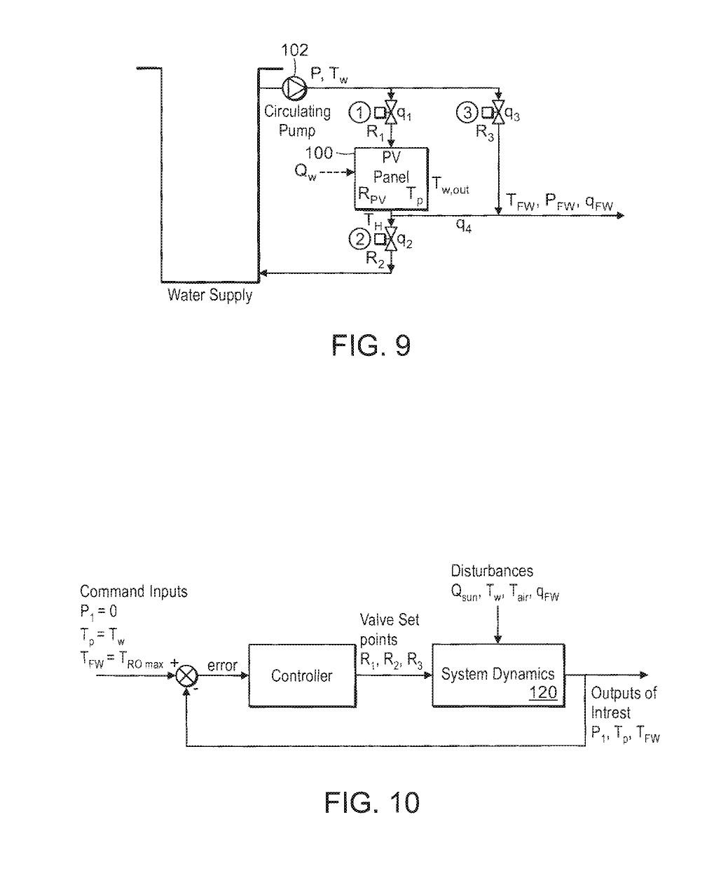

FIG. 9 is a schematic of the portion of the system consisting of the water supply, circulating pump, PV panel and the three valves. This is the thermal subsystem. The thermal subsystem considered here is a multiple input, multiple output (MIMO) system. The panel temperature, RO feed water temperature and the RO feed water pressure are the system outputs of interest, and can he measured with the appropriate temperature and pressure sensors. The temperature of the water supply and the heat transferred to the water in the PV panel heat exchanger are disturbances to the system. The flow resistances through valves 1 through 3 are functions of the positions of the valves. These resistances can be assumed proportional with respect to the percent the valves are open. The flow rate of feed water to the RO system is determined by the RO system dynamics, specifically equations (6), (12), and, if a fixed recovery ratio is assumed:

$${q}_{FW} = \frac{{q}_{p}}{r} \qquad ( 22 )$$

where r is the recovery ratio of fresh water to incoming feed water. Table 2 lists the nomenclature used for the control equations, outputs, commands and disturbances.

TABLE 2
Nomenclature for System Outputs, Commanded
Inputs and States of Interest

| Symbol | Definition |
|---|---|
| Tₚ | Temperature of the solar panel |
| T_{FW} | Temperature of the feed water entering the RO unit |
| P_{FW} | Pressure of the feed water entering the RO boost pump |
| q_{FW} | Volumetric flow rate of the RO feed water, determined by the |
| | RO system Dynamics |
| qₚ | Volumetric flow rate of the fresh water exiting the RO unit |
| r | Recovery ratio, which is the ratio of fresh water to RO feed |
| | water |
| P | Pressure of the water exiting the circulating pump, assumed to |
| | be constant |
| T_{w} | Temperature of the water supply |
| T_{RO,max} | Maximum allowable temperature of the RO feed water |
| q₁ | Volumetric flow rate of water through the PV panel heat |
| | exchanger |
| q₂ | Volumetric flow rate of water from the heat exchanger that |
| | bypasses the RO unit |
| q₃ | Volumetric flow rate of water bypassing the PV panel heat |
| | exchanger |
| q₄ | Volumetric flow rate of water from the heat exchanger that |
| | flows to the RO Unit |
| R₁ | Flow resistance through valve 1, assumed proportional to |
| | percent the valve is open |
| R₂ | Flow resistance through valve 2, assumed proportional to |
| | percent the valve is open |
| R₃ | Flow resistance through valve 3, assumed proportional to |
| | percent the valve is open |
| R_{PV} | Flow resistance through the PV panel heat exchanger, |
| | a function of the flow rate |
| T_{H} | Temperature of the water exiting the PV panel heat exchanger |
| Q_{w} | Heat transferred to the feed water through the PV panel heat |
| | exchanger |
| ρ | Density of the water flowing through the heat exchanger |
| cₚ | Specific heat of the water flowing through the heat exchanger |

The commanded inputs to the system are:

Tₚ=T_{w} (23)

T_{FW}=T_{RO,max} (24)

P_{FW}=0 (25)

The error between the commanded inputs and the measured output values are used by the controller to determine the positions of the valves, which determine the resistances across the valves. The equations that govern the thermal dynamics are as follows, using the nomenclature defined in Table 2. The flow through the PV panel heat exchanger is determined by:

$${q}_{1} = \frac{P - {P}_{FW}}{{R}_{1} + {R}_{PV}} \qquad ( 26 )$$

The flow from the PV heat exchanger that bypasses the RO unit is determined by:

$${q}_{2} = \frac{P - ( {R}_{1} + {R}_{PV} ) {q}_{1}}{{R}_{2}} \qquad ( 27 )$$

The flow from the water supply that bypasses the PV panel heat exchanger is determined by:

$${q}_{3} = \frac{P - {P}_{FW}}{{R}_{3}} \qquad ( 28 )$$

The flow from the PV panel heat exchanger to the RO unit is found using:

q₄=q₁−q₂ (29)

The RO feed water flow is then:

q_{FW}=q₄+q₃ (30)

Substituting Equations (26)-(29) into (30) yields:

$${q}_{FW} = \frac{P - {P}_{FW}}{{R}_{PV} + {R}_{1}} - \frac{P - ( {R}_{1} + {R}_{PV} ) {q}_{1}}{{R}_{2}} + \frac{P - {P}_{FW}}{{R}_{3}} \qquad ( 31 )$$

which describes the feed water flow rate in terms of the pressures, flow resistances and flow rate through the heat exchanger.

The temperature of the water leaving the PV panel heat exchanger is given by:

$${T}_{H} = {T}_{w} + \frac{{Q}_{w}}{ρ {q}_{1} {c}_{p}} \qquad ( 32 )$$

The temperature of the RO feed water is given by:

$${T}_{FW} = \frac{{T}_{w} {q}_{3} + {T}_{H} {q}_{4}}{{q}_{FW}} \qquad ( 33 )$$

The temperature of the solar panel is given by Equation (15), repeated here, using the nomenclature found in Table 1:

$${C}_{pan} \frac{d {T}_{p}}{d t} = {Q}_{sol} - {P}_{elec} - {Q}_{sky} - {Q}_{air} - {Q}_{wtr} \qquad ( 15 )$$

This thermal-fluid network is similar to that of an electrical resistance network. However, the above equations are nonlinear, since the flow resistances through the valves vary with position (percent the valves are open), and the flow resistance through the heat exchanger is dependent on the flow rate through it.

FIG. 10 is a block diagram for a thermal management system using feedback control. The commanded inputs are defined by Equations (22)-(24). Equations (15) and (25)-(33) are all contained within the System Dynamics block 120. The controller equations are yet to be defined. It is unlikely that the RO feed water temperature will ever reach its maximum, so a non-zero error is expected and is acceptable.

There are many control strategies that can be implemented, and selection of a control method will determine the equations governing the controller. One option is to linearize equations (22) through (29) about several desired operating points using, say, Taylor series expansion, and then classical linear feedback control methods can be applied. The linearized system dynamics are then described in matrix form as:

$$( \begin{matrix}{\dot{T}}_{p} \\ {\dot{T}}_{FW} \\ {\dot{P}}_{FW}\end{matrix} ) = ( \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ) ( \begin{matrix}{T}_{p} \\ {T}_{FW} \\ {P}_{FW}\end{matrix} ) + ( \begin{matrix}{b}_{11} & {b}_{12} & {b}_{13} \\ {b}_{21} & {b}_{22} & {b}_{23} \\ {b}_{31} & {b}_{32} & {b}_{33}\end{matrix} ) ( \begin{matrix}{R}_{1} \\ {R}_{2} \\ {R}_{3}\end{matrix} ) \qquad ( 34 )$$

where the coefficients of the A and B matrices are determined by linearization around an operating point. It may be appropriate to linearize the system around several discrete operating points, and then have a higher-level controller decide which set point to select based on some governing criteria, such as time of day or electrical power produced by the PV panel,

If the linearization method is not effective or appropriate tier some states, other control methods, such as fuzzy logic and impedance control, can be applied.

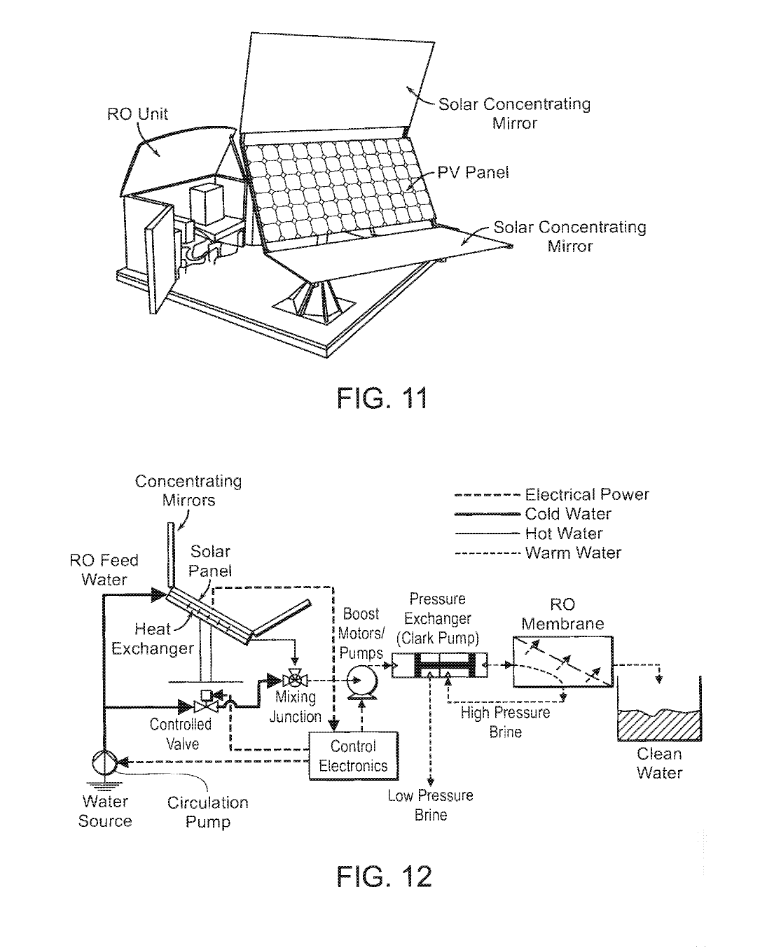

An experimental PV/RO system for seawater desalination has been designed and constructed, see FIG. 11. The system includes two low-pressure boost pumps, a high-pressure Clark pump, RO membrane within an RO pressure vessel, a plastic water tank, a PV panel and a sun tracking system. It also incorporates a fiat-plate heat exchanger mounted on the back of the solar panel, a supplemental circulation pump, a controlled valve, and a set of manual valves used to reconfigure flow through its piping network in order to perform experiments with and without heating and cooling. Detachable flat-plate solar concentrating mirrors are also mounted on the solar panel, so experiments with and without solar concentration can be performed. A schematic representation of the system is shown in FIG. 12.

The performance of a small scale PV/RO system with a thermal controller was simulated (see FIG. 12), using the system equations outlined above. The following assumptions and factors were made in the simulation:
A small centrifugal circulation pump is used.
The maximum allowable pressure at the heat exchanger inlet is 6 psi, with a maximum allowable flow rate of 0.0631 L/s. This is due to the limits of the commercial heat exchanger purchased for experimental validation. A properly sized heat exchanger would not have a limiting pressure.
Water is uniformly mixed within the RO unit
The incoming feed water temperature is 15° C., with a salinity of 35,000 ppm.
The system is operating on a rooftop in Cambridge, Mass., on a clear November day with no wind.
The system has a fixed energy recovery ratio of 0.09. This is the ratio of the clean water flow rate to the feed water flow rate. This also means the polarization factor in Equation (9) is constant.
Nominal production of fresh water is 300-400 liters per day.
The electronics implement maximum power point tracking.
Solar concentrating mirrors provide 2.5 suns insolation on the PV panel.
Heat transfer convection coefficients for air and water are assumed constant.
   Parameters used in the simulations are shown in Table 3. Equations (6)-(9), (11), and (13)-(21) are used in the simulations.

TABLE 3
Numerical Values for Simulation Parameters

| | |
|---|---|
| Panel Power Rating (W) | 230 |
| ηₚ [3] | 17.9% |
| k [3] | −0.0038 |
| Cₚₐₙ (J/° C.) [5] | 7119.7 |
| Aₚ (m²) [3] | 1.2401 |
| T_{sky} (K) [6] | 268 |
| hₐᵢᵣ (W/m²-° C.) [7] | 10 |
| h_{wtr} (W/m²-° C.)* | 23 |
| ε [5] | 0.95 |
| T_{std} (° C.) [3] | 25 |
| T_{w,in} (° C.) | 15 |
| ρ_{sw} (kg/m³) [8] | 1023.34 |
| cₚ (J/kg-° C.) [8] | 3993 |
| K (L/s-bar-m²) [2] | 3.3492 × 10⁻⁴ |
| B (L/s-m²) [2] | 2.098 × 10⁻⁵ |
| pf | 1.065 |
| Aₘ (m²) [2] | 2.6 |
| σ (W/m²-K⁴) [6] | 5.67 × 10⁻⁸ |

*Based on experimental data provided by the heat exchanger manufacturer.

The following cases were simulated:
Conventional operation (i.e. no temperature control)
Operation with PV panel cooling with separate supply water and hence no RO water warming
Operation with PV panel cooling with RO feed water warming, operation using solar concentrators with PV panel cooling and no RO feed water heating
Operation using solar concentrators along with PV panel cooling using the RO feed water

Results from e simulations, run for the duration of a full November day (from sunrise to sunset) are presented n Table 4.

TABLE 4
Simulation Results for a Small-Scale PV/RO System

| | | | | % Increase in |
|---|---|---|---|---|
| Rooftop System: | Tₚ | T_{RO max} | Clean Water | Water |
| November | (° C.) | (° C.) | Produced (L/day) | Produced |
| No Thermal | 44 | 15 | 314 | 0% |
| Management | | | | |
| Cooling Alone | 34 | 15 | 321 | 2% |
| Cooling + Heating | 34 | 16 | 334 | 6% |
| Cooling + | 70 | 15 | 463 | 47% |
| Concentrating (No | | | | |
| Heating) | | | | |
| Cooling + Heating + | 70 | 17 | 490 | 56% |
| Concentrating | | | | |

The results suggest that a modest increase in clean water production is achievable with thermal management. Adding solar concentrating mirrors to a thermally controlled system can potentially increase the total water produced by approximately 50%. Although the PV panel does not overheat here, its maximum temperature when cooled without concentrating mirrors is 10 degrees lower than when it isn't cooled.

The system with thermal management was tested in mid-November, and was run for 6 hours. Here, thermal management consisted of a constant pump and valve set-points. The system was also run without thermal management for a conventional system configuration, for comparison. The experimental results show an increase in panel power produced and in total daily water production when thermal management is implemented, and agree well with the simulated results when both concentrating mirrors and thermal management are used.

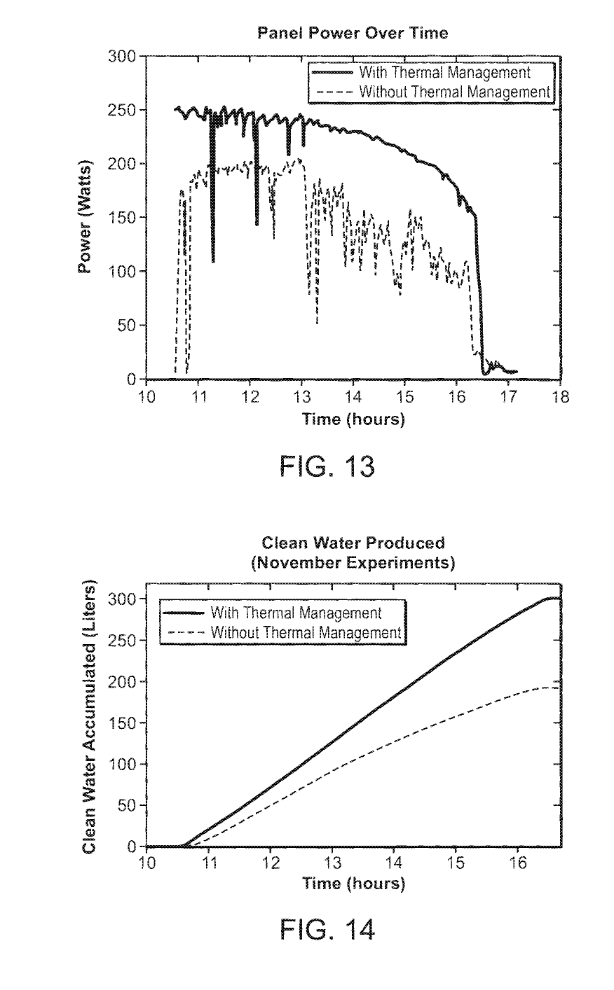

FIG. 13 shows the electrical power produced by the solar panel over the course of the day. As expected, the system with thermal management and concentrators produces much more power. The afternoon was partly cloudy the day the system without thermal management was run, hence the large fluctuations in power production in the afternoon.

FIG. 14 shows the clean water produced over the course of the day, adjusted for he difference in experimental starting times. A 57% increase in total fresh water produced was achieved with thermal management and solar concentrators.

Table 5 compares the experimental and simulated cumulative water produced. The simulation results in this table are different from those in Table 4, because the simulations in Table 4 were run from sunrise to sunset. The simulation results in Table 5 are for the same hours of the day that the experimental system was run, a total of 6 hours. The experimental and simulated results agree well when solar concentrators and thermal management are used.

TABLE 5
Comparison of Simulated and Experimental Cumulative Water Produced

| | | | | | % Increase in | % Increase in |
|---|---|---|---|---|---|---|
| | | | Clean Water | Clean Water | Water | Water |
| Rooftop System | Tₚ | T_{RO max} | Produced (L/Day) | Produced (L/Day) | Produced | Produced |
| November | (° C.) | (° C.) | (Sim) | (Exp) | (Sim) | (Exp) |
| No Thermal | 44 | 15 | 188 | 191 | 0% | 0% |
| Management | | | | | | |
| Cooling + Heating + | 70 | 17 | 282 | 300 | 50% | 57% |
| Concentrating | | | | | | |

A conceptual design of an optimal thermal controller for a PV/RO system has been presented. The way in which the controller manages the temperatures of the PV panel and RO feed water under three different scenarios is described: operation under “normal” conditions in which the PV panel is cooled and the RO feed water is heated to a temperature below its allowable maximum temperature, operation when the RO feed water is too warm, and operation when the PV panel requires more cooling water than needed by the RO unit.

Simulations of a small-scale PV/RO system with temperature control indicate that substantial performance improvements are possible. These thermal control results were validated on an experimental PV/RO system. The system was tested with thermal management and solar concentrators, and without thermal management or solar concentrators. Experimental and simulated results for the system with solar concentrators and thermal management agree, showing that the approach is promising.

### REFERENCES

[1] S. R. Wenham, M. A. Green, M. E. Watt, and R. Corkish, Applied Photovoltaics, London: Earthscan, 2007.
[2] “FILMTEC Tape-Wrapped 2540 Elements for Commercial Applications.” vol. Form No. 609-09030-0606 Dow Chemical Corporation. Available http://www.dow.com. Accessed 10 Dec. 2010.
[3] “Sun Power Corp. 215 Watt Panel “, S. P. Corp., Ed.: Sun Power Corp. Document #001-42024 Rev*A March 2009.
[4] “FILMTEC Membranes System Design: System Performance Projection.” vol. Form Number 609-02057-604 Dow Chemical Corporation. Available http://www.dow.com. Accessed 13 Dec. 2010.
[5] A. D. Jones and C. P. Underwood, “A thermal model for photovoltaic systems,” Solar Energy, vol. 70, pp. 349-359, 2001.
[6] Y. A. Cengel, Heat Transfer: A Practical Approach, 3rd ed. Boston: McGraw Hill, 2003.
[7] L. Jiji, Heat Transfer Essentials, 2nd ed. New York: Begell House, Inc., 2002.
[8] “2.7.9 Physical Properties of sea water. Kaye and Laby Table of Physical and Chemical Constants Online.,” England and Wales: National Physics Laboratory, 2009. Available: http://www.kayelaby.npl.co.uk/general physics/2_{—}7/2_{—}7_{—}9.html. Accessed 11 Feb. 2010.

What is claimed is:

1. Photovoltaic-powered reverse osmosis system comprising;
a photovoltaic panel for generating electricity including a heat exchanger in thermal contact therewith;
a reverse-osmosis unit for receiving salt-containing feed water to produce clean water therefrom; and
fluid circuitry including a pump for circulating at least a portion of the feed water through the heat exchanger to cool the photovoltaic panel and to heat the feed water, and for delivering the heated feed water to the reverse osmosis unit for desalination.

2. The system of claim 1 further including a thermal controller for controlling the flow of the feed water through the fluid circuitry for easing clean water production by managing temperatures of the photovoltaic panel and the feed water.

3. The system of claim 1 wherein temperature the photovoltaic panel is minimized.

4. The system of claim 1 wherein the reverse osmosis feed water temperature is maximized subject to a constraint on maximum temperature.

5. The system of claim 1 wherein the pump is powered by electricity from he photovoltaic panel.

6. The system of claim 2 wherein the thermal controller includes an embedded microcontroller.

7. The system of claim 1 further including solar concentrators for delivering additional solar energy to the photovoltaic panel.

8. The system of claim 1 wherein the system is constructed from modular components.
